(19) United States
(12) Patent Application Publication
(10) Pub. No.: US 2018/0125177 A1
(43) Pub. Date: May 10, 2018

(54) TWO-PART SLAP WATCHBAND WITH INTEGRAL PIN RECEIVING CHANNELS AND METHOD FOR MAKING SAME

(71) Applicant: WATCHITUDE, LLC, New Brunswick, NJ (US)

(72) Inventor: ALBERT HAKIM, Eatontown, NJ (US)

(21) Appl. No.: 15/806,424

(22) Filed: Nov. 8, 2017

Related U.S. Application Data
(60) Provisional application No. 62/419,723, filed on Nov. 9, 2016.

(51) Int. Cl. A44C 5/00; B29C 45/14; G04B 37/14

(52) U.S. Cl. CPC A44C 5/0053; B29K 2083/00; G04B 37/1493; B29C 45/14819

(57) ABSTRACT

The slap watchband includes first and second band parts. Each part has an end adapted to attach to a conventional watch casing using a spring-loaded pin. Each part includes a flexible metal strip encased in plastic and a channel in the plastic located proximate the end adapted to receive a spring-loaded pin. The parts are formed in a multi cavity mold by introducing plastic into the mold cavities to form a plastic layer. A flexible metal strip is placed in each mold cavity over the plastic layer. A rod is inserted into the mold such that it extends across the each mold cavity at a location spaced from the metal strip. Additional plastic is introduced into the mold cavities over the flexible metal strip and rod to form another plastic layer. The mold is closed. Heat and pressure are applied to cure the plastic layers and the rod is removed.

### CROSS-REFERENCE TO RELATED APPLICATIONS

Priority is claimed on Provisional Patent Application No. 62/419,723, filed Nov. 9, 2016, the contents of which are incorporated herein by reference.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

### 1. Field of the Invention

The present invention relates to watchbands and more particularly, to a two-part slap watchband with integral pin receiving channels and a method for making same.

### 2. Description of Prior Art Including Information Disclosed Under 37 CFR 1.97 and 1.98

A conventional slap watchband is made of a single flexible steel strip encased in silicone. The watchband is configured to “flex” between a generally planar state and a curved state where it automatically curls around the wrist of the wearer after it is “slapped” against the wrist of the wearer.

The conventional slap watchband is designed to be used with a watch casing specifically designed for use with a slap watchband. The watch casing is provided with a slot or other means for engaging the central portion of the slap watchband adjacent the rear surface of the watch casing. The band is inserted through the slot or other engaging means to mount the watch casing on the watchband.

A conventional watch casing is designed for use with a watchband which has two separate sections. The conventional watch casing is attached between the two watchband sections. It has two spaced protruding parts with inwardly facing recesses at either side. The recesses are situated to accept the ends of spring-loaded pins, each of which pins is associated with a different one of the two watchband sections.

The conventional slap watchband cannot be used with a conventional watch casing because the slap watchband is a single piece and has no structure or other means to attach to the side of a conventional watch casing. Thus, the types of watches which can be used with conventional slap watchbands bands are very limited.

It would be advantageous to have a slap watchband which could be used with all conventional watch casings. Further, it would be advantageous to have a method of making a slap watchband which could be used with all conventional watch casings.

### BRIEF SUMMARY OF THE INVENTION

It is therefore a prime object of the present invention to provide a two-part slap watchband which can be used with all conventional watch casings.

It is also a prime object of the present invention to provide a method of manufacturing a two-part slap watchband which can be used with all conventional watch casings.

In accordance with one aspect of the present invention, a slap watchband including first and second band parts is provided. Each of the band parts has an end adapted to attach to a side of a conventional watch casing of the type configured to receive a spring-loaded pin. Each band part includes a flexible metal strip encased in plastic and a channel adapted to receive a spring-loaded pin within the plastic located proximate to the end of the band part.

In accordance with another aspect of the present invention, a combination of a watch casing configured to accept a spring-loaded pin and a slap watchband are provided. The watchband has first and second band parts. Each of the band parts includes a flexible metal strip encased in plastic and has an end adapted to attach to the watch casing. The end of each of the band parts includes a channel adapted to receive a spring-loaded pin within the plastic proximate the end of the band part.

Preferably, the plastic is silicone and the metal is steel.

The metal strip has an end. The metal strip end is spaced from the channel.

In accordance with another aspect of the present invention, a method is provided for making a slap watchband part in a mold having a top and a bottom moveable relative to each other between an open position and a closed position, and a cavity having an end. The method comprises the steps of introducing plastic into the cavity to form a plastic layer with the mold in the open position. A flexible metal strip is placed in the mold cavity over the plastic layer. A rod is inserted into the mold cavity such that the rod extends across the mold cavity at a location spaced from the metal strip. Additional plastic is then introduced into the mold cavity over the flexible metal strip and rod to form another plastic layer. The top mold part is closed over the bottom mold part. Heat and pressure are applied to cure the plastic to form the band part. The rod is removed from the mold. The band part is then removed from the mold.

In accordance with another aspect of the present invention, a method is provided for making a two-part slap watchband in a mold having a top and a bottom moveable relative to each other between an open position and a closed position, and first and second spaced mold cavities each having an end. The method includes the steps of introducing plastic into each cavity to form a plastic layer therein, with the mold in the open position. A flexible metal strip is placed in each mold cavity over the plastic layer therein. A first rod is inserted into the first mold cavity such that the rod extends across the first mold cavity at a location spaced from the metal strip therein. A second rod is inserted into the second mold cavity such that the second rod extends across the second mold cavity spaced at a location spaced from the metal strip therein. Additional plastic is introduced into each mold cavity over the flexible metal strip and rod to form another plastic layer therein. The top of the mold is closed over the bottom of the mold part. Heat and pressure are applied to cure the plastic to form the band part. The first and second rods are removed from the mold. The band parts are then removed from the mold.

Preferably, the plastic is introduced into the mold cavities in paste form.

Preferably, the plastic is silicone and the metal strips are steel.

### BRIEF DESCRIPTION OF THE SEVERAL VIEWS OF DRAWINGS

To these and to such other objects that may hereinafter appear, the present invention relates to a two-part slap watchband and a method of making same as described in detail in the following specification and recited in the annexed claims, taken together with the accompanying drawings, in which like numerals refer to like parts and in which:

FIG. 1 is a perspective view of a conventional watch casing with the two-part slap watchband of the present invention attached;

FIG. 2 is an exploded perspective view of the watch casing and two-part slap watchband of FIG. 1;

FIG. 3 is as side elevation view of the watch casing and one of the watchband parts of FIG. 1 in which the elements of the watchband part are exploded,

FIG. 4 is a top plan view of the bottom of a mold showing two rows of mold cavities with the first layer of silicone in each cavity;

FIG. 5 is a top plan view of the bottom of the mold showing the mold cavities with the metal strips in placed on the first layer of silicone in each cavity;

FIG. 6 is a top plan view of the bottom of the mold showing the mold cavities with rods inserted across each row of cavities over the first layer of silicone in each cavity;

FIG. 7 is a top plan view of the bottom of the mold showing the mold cavities with the second layer of silicone over the rods and metal strips in each cavity;

FIG. 8 is a perspective of the bottom of the mold of FIG. 7 with the top of the mold being closed over the bottom of the mold;

FIG. 9 is a perspective view of the mold after the top and bottom of the mold are opened and a finished slap watchband part is being removed; and

FIG. 10 is a flow chart of the steps of the manufacturing process.

### DETAILED DESCRIPTION OF THE INVENTION

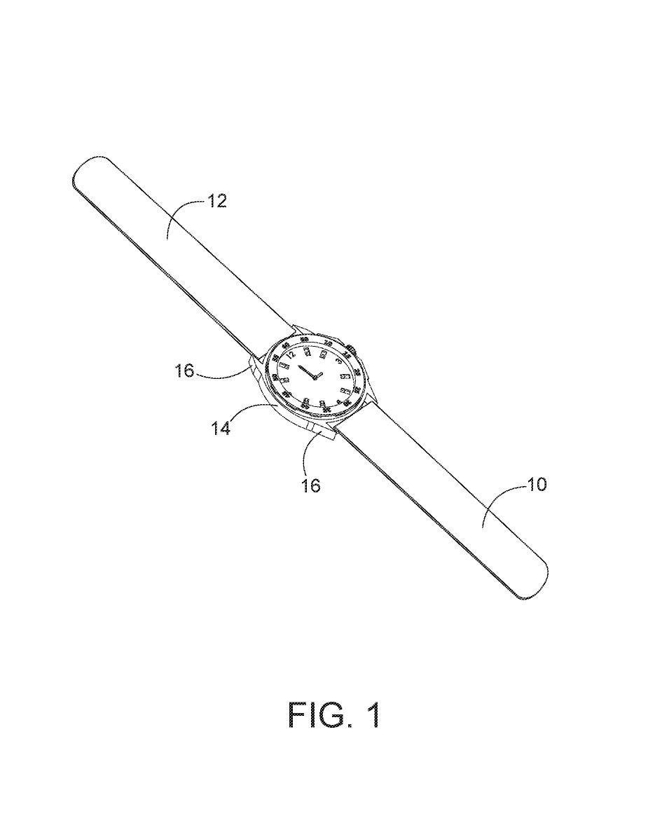

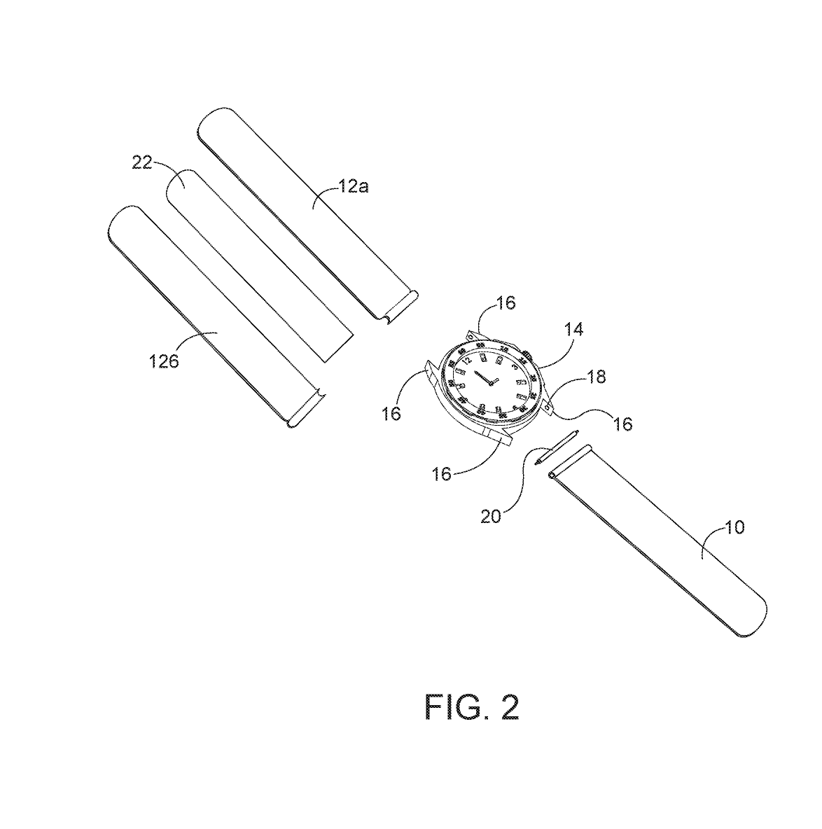

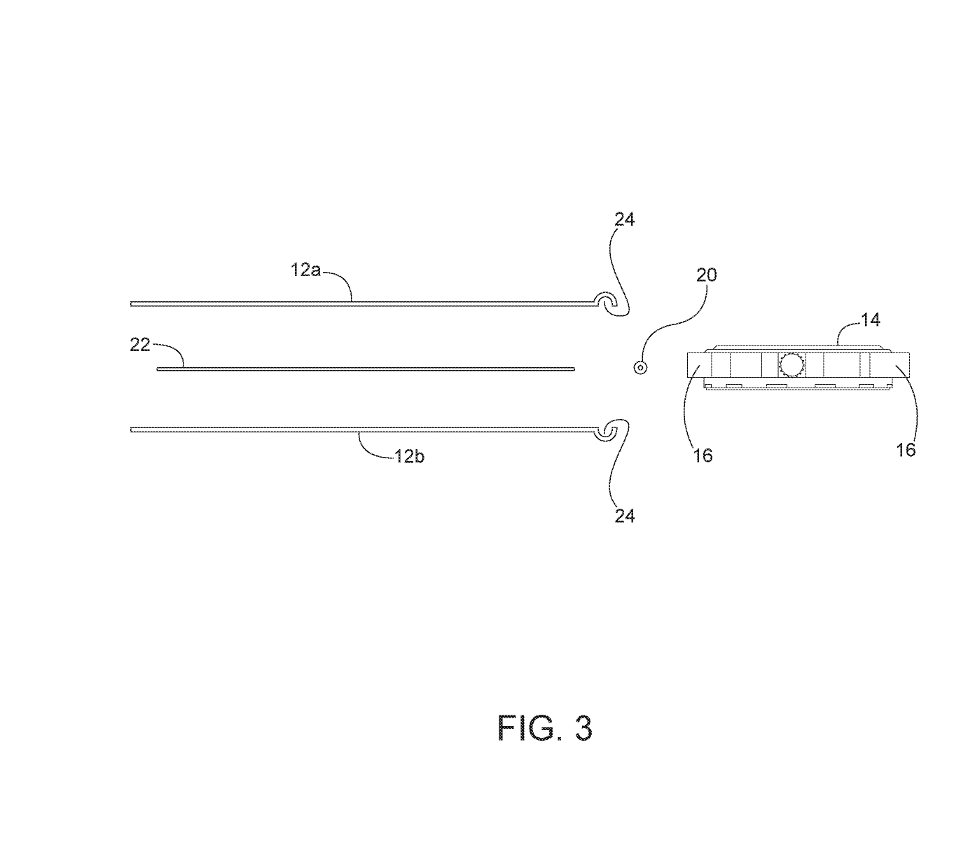

As illustrated in FIGS. 1-3, the present invention related to a slap watchband consisting of two band parts 10, 12 designed for use with any conventional watch casing 14. The watch casing includes, at either side, spaced protruding members 16 with inward facing recesses 18 adapted to receive conventional spring-loaded connector pins 20.

Each part 10, 12 of the slap watchband includes a flexible metal strip 22 encased in plastic, preferably silicone. The metal strip 22 is preferably made of steel.

As explained below, during the molding process, a channel 24 is formed in the end of the silicone casing of each watchband part. Channel 24 is designed to receive a spring-loaded pin 20 such that the end of the watchband part can be attached to one of the sides of the watch casing, as with a conventional watchband. The end of embedded metal strip is spaced a short distance from channel 24.

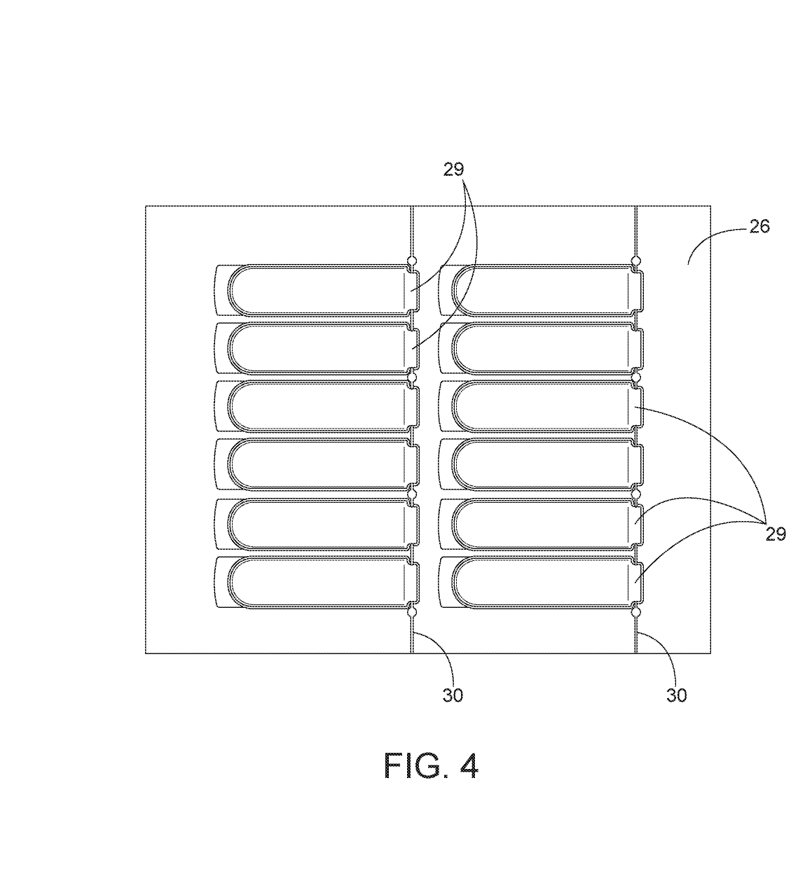

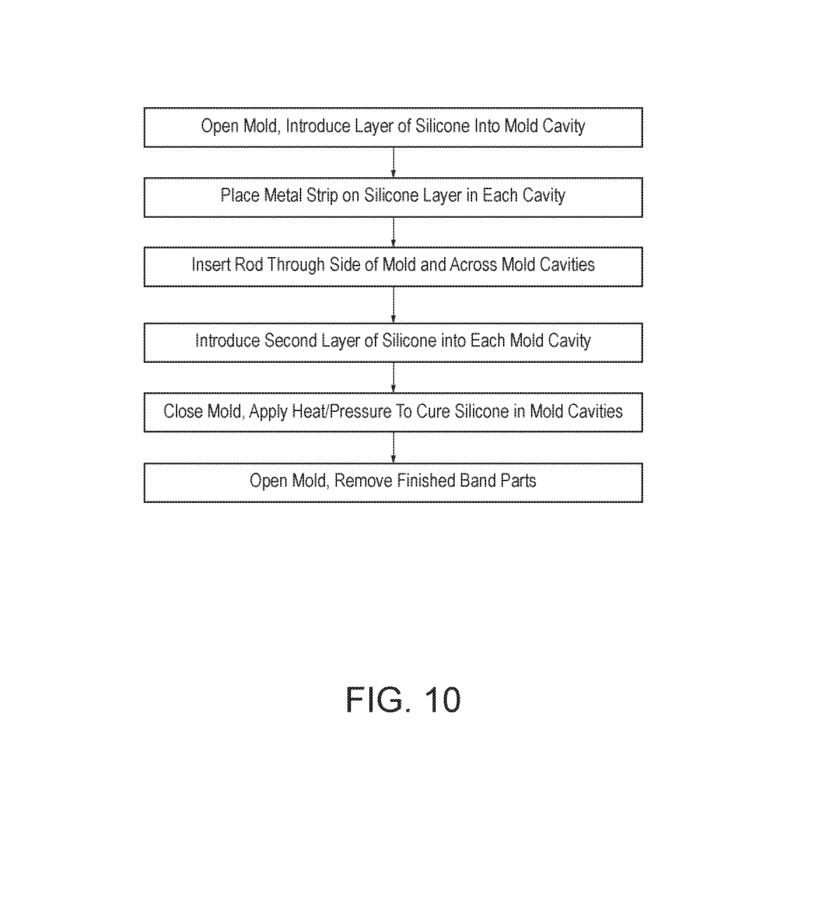

FIGS. 4-9 illustrate the method of manufacturing the two-part slap watchband of the present invention. FIG. 10 is a flow chart of the manufacturing steps.

The watchband of the present invention is manufactured in a multi-cavity mold having a bottom 26 and a top 28. Each of the top and bottom of the mold has two rows of mold cavities, as seen in FIG. 4. Each mold cavity has a recess 29 extending across the cavity at the end where the channel 24 will be formed. Aligned with recesses in each row is a slot 30 which extends from one side of the mold part to the other. The purpose for the slots in the mold is explained below.

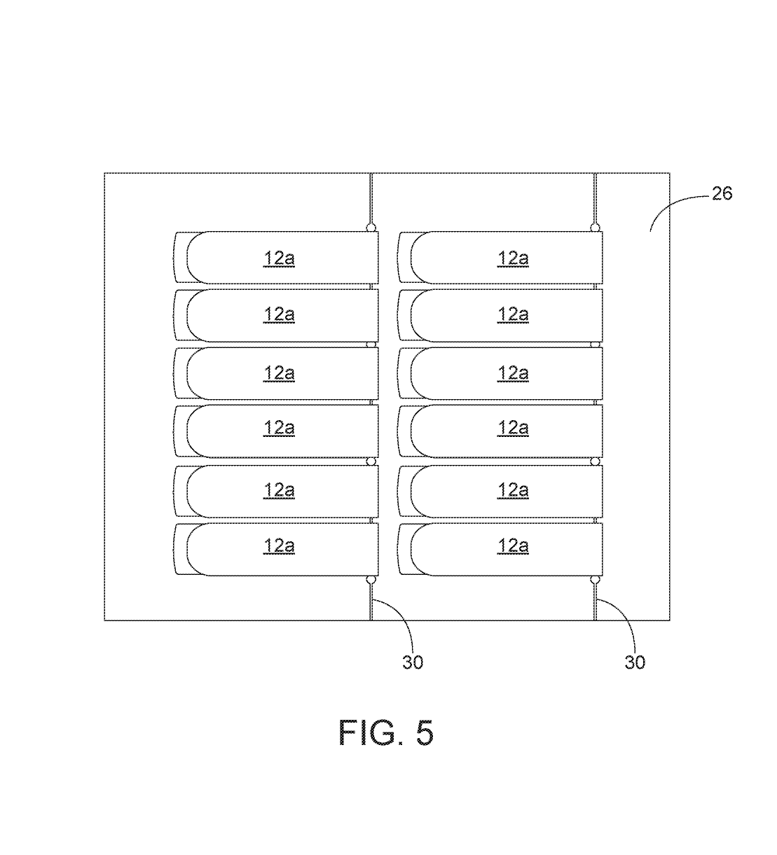

As illustrated in the drawings and set forth in the flow chart of FIG. 10, with the mold open, plastic material, preferably silicone in paste form, is introduced into each cavity in the bottom 26 of the mold to form a first silicone layer 12a in each cavity, as seen in FIG. 5.

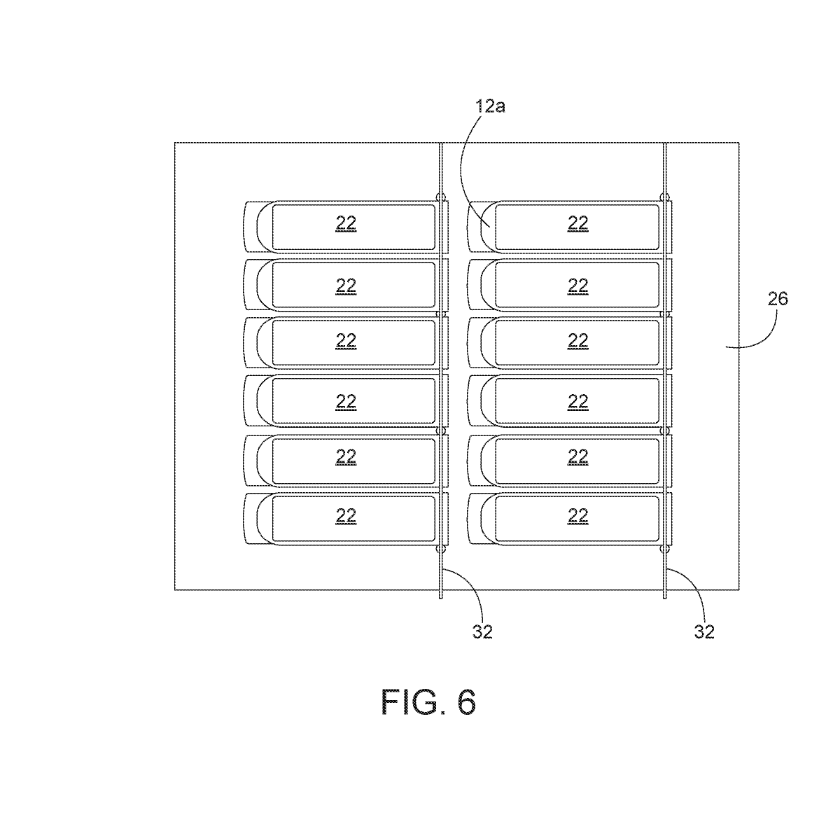

Next, a metal strip 22 is placed over the first silicone layer 12a in each cavity. First and second rods 32 are inserted from the side of the mold part through different slots 30 such that each rod extends across the cavities in a different one of the rows above the first silicone layers, as illustrated in FIG. 6. Each rod 32 has a diameter that is slightly larger than the diameter of the spring-loaded pin 20 which will be received in the channel 24 that will be formed proximate to the end of band part after the rods are withdrawn.

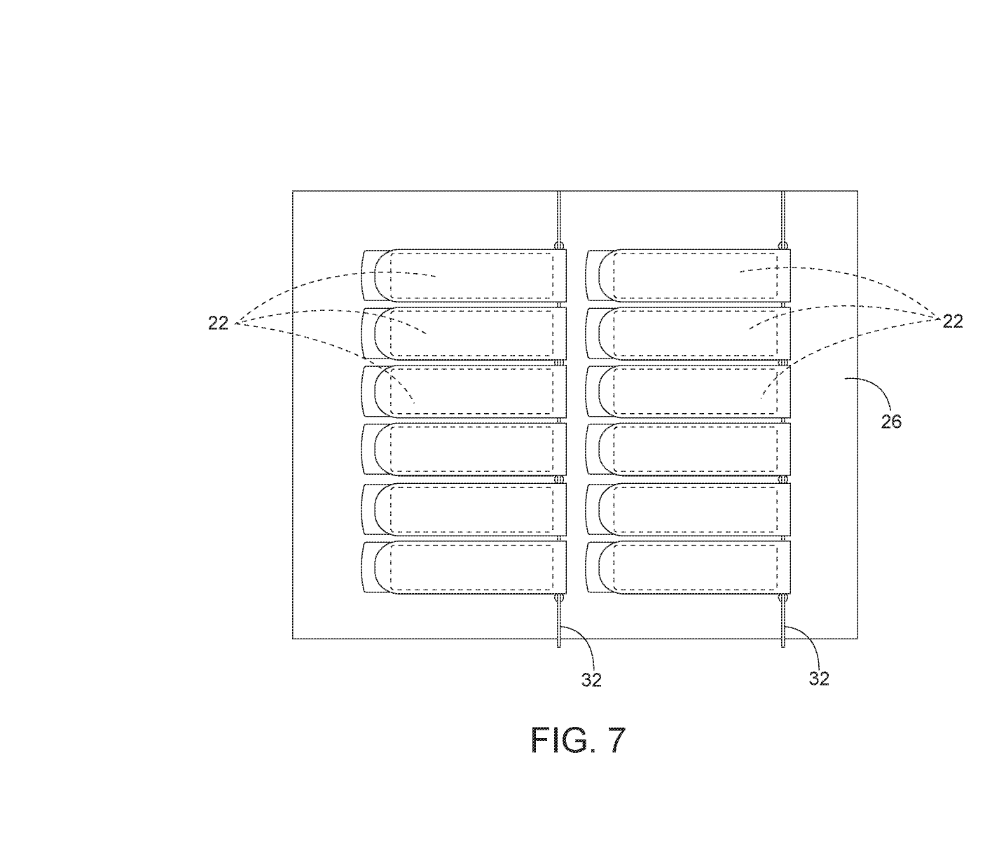

With the rods in place, additional silicone is introduced into each cavity to cover the metal strip and rod therein, see FIG. 7. Rods 32 prevent the additional silicone from filling the entire recess 29 at the end of each cavity such that the channel 24 can be formed in each watchband part.

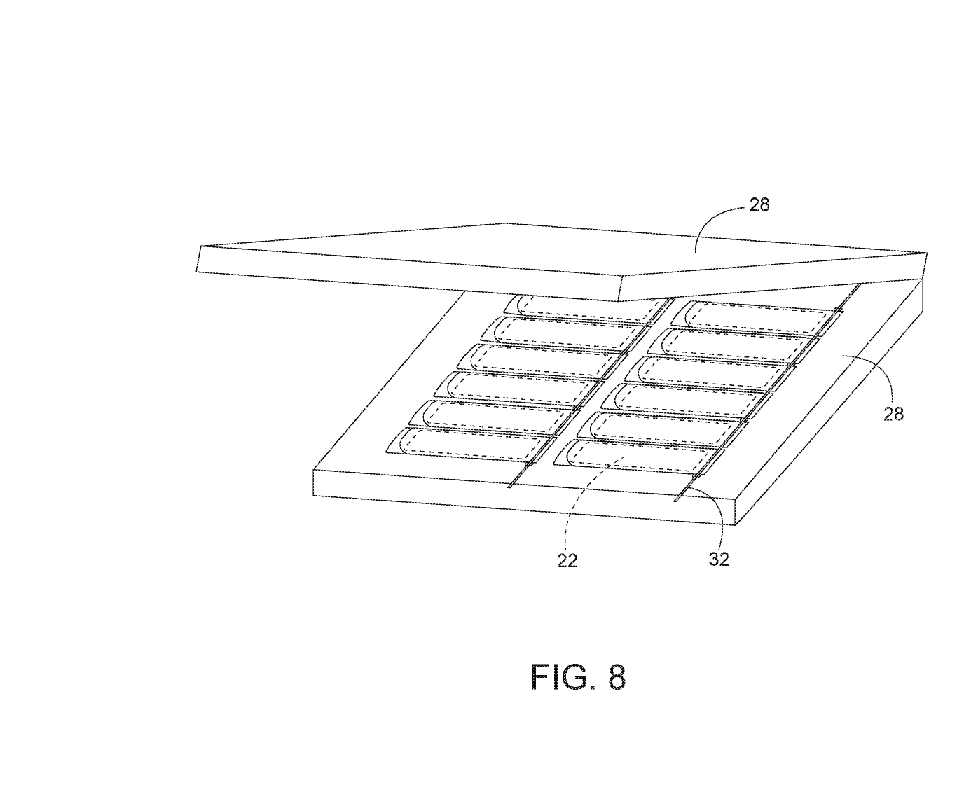

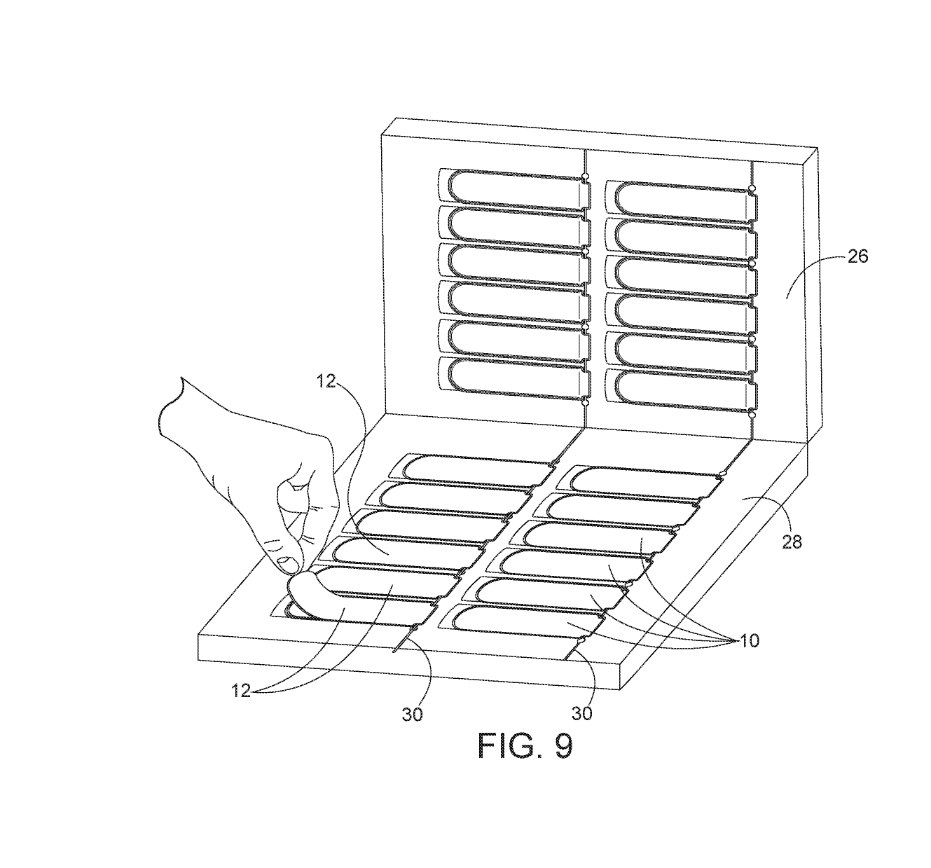

The top of the mold is then closed over the bottom of the mold, as seen in FIG. 8. Heat and pressure are applied to cure the silicone layers to completely enclose the metal strips and rod section in each cavity. After the silicone cools, the mold is opened and the rods are withdrawn leaving an unobstructed channel 24 proximate one end of each watchband part. The channel is spaced a short distance from the end of the metal strip. The slap watchband parts are then completed and can removed from the mold, as seen in FIG. 9.

After the finished watchband parts are removed, a spring-loaded pin is inserted into each channel in each watchband part and the watchband parts are connected to a conventional watch casing in the same manner as a conventional watchband.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims:

I claim:

1. A slap watchband comprising first and second band parts, each of said band parts having an end adapted to attach to a side of a conventional watch casing of the type configured to receive a spring-loaded pin and comprising a flexible metal strip encased in plastic and a channel adapted to receive a spring-loaded pin within said plastic located proximate said end of said band part.

2. The band of claim 1 wherein the plastic comprises silicone.

3. The band of claim 1 wherein the metal is steel.

4. The band of claim 1 wherein said metal strip has an end and wherein said end of said metal strip is spaced from said channel.

5. In combination, a watch with a casing configured to accept a spring-loaded pin and a slap watchband comprising a first band part and a second band part, each of said band parts comprising a flexible metal strip encased in plastic and having an end adapted to attach to said watch casing, said end of said band part comprising a channel adapted to receive a spring-loaded pin within said plastic located proximate said end of said band part.

6. The combination of claim 5 wherein the plastic comprises silicone.

7. The combination of claim 5 wherein the metal comprises steel.

8. The combination of claim 5 wherein said metal strip has an end and wherein said metal strip end is spaced from said channel.

9. A method of making a slap watchband part in a mold having a top and a bottom moveable relative to each other between an open position and a closed position, and a cavity having an end, the method comprising the steps of:
(a) with the mold in the open position, introducing plastic into the cavity to form a plastic layer;
(b) placing a flexible metal strip in the mold cavity over the plastic layer;
(c) inserting a rod into the mold cavity such that the rod extends across the end of the mold cavity at a location spaced from the metal strip
(d) introducing plastic into the mold cavity over the flexible metal strip and rod to form another plastic layer;
(e) closing the top of the mold over the bottom of the mold;
(f) applying heat and pressure to cure the plastic to form the band part;
(g) removing the rod from the mold; and
(h) removing the band part from the mold.

10. The method of claim 9 wherein plastic is introduced into the mold cavity in paste form.

11. The method of claim 9 wherein the plastic comprises silicone.

12. The method of claim 9 wherein the metal strip comprises steel.

13. A method of making a two-part slap watchband in a mold having a top and a bottom moveable relative to each other between an open position and a closed position, and a first and second spaced mold cavities each having an end, the method comprising the steps of:
(a) with the mold in the open position, introducing plastic into each the cavity to form a plastic layer therein;
(b) placing a flexible metal strip in each mold cavity over the plastic layer therein;
(c) inserting a first rod into the first mold cavity such that the rod extends across the end of the first mold cavity at a location spaced from the metal strip therein;
(d) inserting a second rod into the second mold cavity such that the rod extends across the end of the second mold cavity at a location spaced from the metal strip therein;
(e) introducing plastic into each mold cavity over the flexible metal strip and rod therein to form another plastic layer therein;
(f) closing the top of the mold over the bottom of the mold;
(g) applying heat and pressure to cure the plastic to form the band parts;
(h) removing the first and second rods from the mold; and
(i) removing each band part from the mold.

14. The method of claim 13 wherein plastic is introduced into the mold cavities in paste form.

15. The method of claim 13 wherein the plastic comprises silicone.

16. The method of claim 13 wherein the metal strips comprises steel.
